(19) United States
(12) Patent Application Publication
(10) Pub. No.: US 2020/0117822 A1
(43) Pub. Date: Apr. 16, 2020

(54) DYNAMIC AUTHORIZATION MATRIX AND RELATED SYSTEMS, METHODS, AND COMPUTER PROGRAM PRODUCTS

(71) Applicant: CA, Inc., New York, NY (US)

(72) Inventors: Arijit Dey, Hyderabad (IN); Varunkumar Mallisetty, Hyderabad (IN)

(21) Appl. No.: 16/159,295

(22) Filed: Oct. 12, 2018

(51) Int. Cl. G06F 21/62; G06F 21/60; G06F 17/30; H04L 29/06

(52) U.S. Cl. CPC G06F 21/6227; G06F 21/604; G06F 2221/2141; H04L 63/102; G06F 17/30165

(57) ABSTRACT

A method includes performing, by a processor, operations including: generating an approval routing matrix that is configured to associate a route with at least one a plurality of roles for accessing a record in a storage medium, the record being representative of a matter for approval, receiving a request to approve the matter, generating an assignment matrix based on the approval routing matrix, the assignment matrix being configured to specify an order in which the at least one of the plurality of roles are granted access to the record, allowing access to the record to at least one user associated with the at least one of the plurality of roles, respectively, in the order specified in the assignment matrix, and determining whether the matter is approved based on input received by the at least one user associated with the at least one of the plurality of roles, respectively.

### BACKGROUND

The present disclosure relates to computer systems, and, in particular, to methods, systems, and computer program products for processing a matter for approval.

Business enterprises may have internal business processes that have been automated to improve efficiency. They may have workflows with rules conforming to the organizational processes to automate the day to day activities. Approvals and authorizations may also be automated where a sequence of steps are required to approve a record. For example, the steps required to approve a record may be defined in the workflow and, as the workflow execution progresses, different participants in the whole approval process may act on the record to either approve or reject the record.

Many approval processes are implemented as workflows where the sequence of steps required for a particular approval process is defined and deployed into the enterprise's workflows. Any change required in the approval process typically requires a cancellation of the currently executing workflow process and redeployment of the workflow. Also, different entities in the enterprise may require different approval processes. As a result, one approval process may not be able to cater to all of the approval scenarios.

### SUMMARY

In some embodiments of the inventive subject matter, a method comprises, performing by a processor, operations comprising: generating an approval routing matrix that is configured to associate a route with at least one a plurality of roles for accessing a record in a storage medium, the record being representative of a matter for approval, receiving a request to approve the matter, generating an assignment matrix based on the approval routing matrix, the assignment matrix being configured to specify an order in which the at least one of the plurality of roles are granted access to the record, allowing access to the record to at least one user associated with the at least one of the plurality of roles, respectively, in the order specified in the assignment matrix, and determining whether the matter is approved based on input received by the at least one user associated with the at least one of the plurality of roles, respectively.

In other embodiments of the inventive subject matter, a system comprises a processor and a memory coupled to the processor and comprising computer readable program code embodied in the memory that is executable by the processor to perform operations comprising: generating an approval routing matrix that is configured to associate a route with at least one a plurality of roles for accessing a record in a storage medium, the record being representative of a matter for approval, receiving a request to approve the matter, generating an assignment matrix based on the approval routing matrix, the assignment matrix being configured to specify an order in which the at least one of the plurality of roles are granted access to the record, allowing access to the record to at least one user associated with the at least one of the plurality of roles, respectively, in the order specified in the assignment matrix, and determining whether the matter is approved based on input received by the at least one user associated with the at least one of the plurality of roles, respectively.

In further embodiments of the inventive subject matter, a computer program product comprises a tangible computer readable storage medium comprising computer readable program code embodied in the medium that is executable by a processor to perform operations comprising: generating an approval routing matrix that is configured to associate a route with at least one a plurality of roles for accessing a record in a storage medium, the record being representative of a matter for approval, receiving a request to approve the matter, generating an assignment matrix based on the approval routing matrix, the assignment matrix being configured to specify an order in which the at least one of the plurality of roles are granted access to the record, allowing access to the record to at least one user associated with the at least one of the plurality of roles, respectively, in the order specified in the assignment matrix, and determining whether the matter is approved based on input received by the at least one user associated with the at least one of the plurality of roles, respectively.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including an approval server for managing approval requests using a dynamic authorization matrix in accordance with some embodiments of the inventive subject matter;

FIG. 2 illustrates a data processing system that may be used to implement the approval server of FIG. 1 in accordance with some embodiments of the inventive subject matter;

FIG. 3 is a block diagram that illustrates a software/hardware architecture for use in an approval server for managing approval requests using a dynamic authorization matrix in accordance with some embodiments of the inventive subject matter;

FIGS. 4, 5, 6A, 6B, and 7 are flowchart diagrams that illustrate operations for use in an approval server for managing approval requests using a dynamic authorization matrix in accordance with some embodiments of the inventive subject matter;

FIG. 8 is a block diagram that illustrates an approval routing matrix in accordance with some embodiments of the inventive subject matter; and

FIG. 9 is a block diagram that illustrates an assignment matrix in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it is not limited to, a hardware element, firmware component, and/or software component. A data processing system may be configured with one or more data processing facilities.

Embodiments of the inventive subject matter are described herein in the context of generating a dynamic authorization matrix that may comprise and/or represent one or more matrices, such as an approval routing matrix and an assignment matrix. The matrices described herein may be implemented in different ways in accordance with various embodiments of the inventive subject matter including, but not limited to, a relational database model, such as a DB2 database, a flat database model, a hierarchical database model, a network database model, an object-relational database model, and a star schema database model. In other embodiments, the matrices may be implemented using one or more data structures, such as an array, a linked list, and the like.

Some embodiments of the inventive subject matter stem from a realization that approval processes may lack the flexibility to adapt to changing organizational operation models, such as, for example, a change in organizational breakdown structure, a change in approval authority, or the addition/subtraction of approvers to a current approval process. It may not be possible to make changes to an approval process that is already in progress. Any changes to an approval process, even for a particular record, may require a change in the workflow design and a subsequent cancellation and re-deployment of the workflow/approval process.

According to some embodiments of the inventive subject matter, approval requests may be managed using a dynamic authorization matrix for any type of entity that requires approvals, including, but not limited to, financial transactions and change requests. Embodiments of the inventive subject matter are not limited to particular types of records for which the approval process is to be designed and implemented. The dynamic authorization matrix makes use of organizational roles that are representative of participants in the approval process.

Embodiments of the inventive subject matter may include one or more of the following aspects: a generic and dynamic approval process may be provided for any organizational entities, which can range from financial transactions to change requests; approval rules may be dynamically reconfigurable and may be aligned to changing business operational needs; new approval routes may be dynamically introduced and/or existing approval routes may be amended for in-progress approval processes; additional approvals can be introduced as needed to supplement existing approvals; approval processes can be dynamically reconfigured without the need to cancel and/or re-start existing approval processes; approval routing information used by each process may assist in identifying various approval patterns and/or paths within an organization and may contribute to future process improvements; the dynamic approval process can be used with Business Process Management (BPM) tools and may augment workflow/process flow tools to facilitate dynamic approvals; and the dynamic approval process may obviate the need for hard coded process definitions and rules for processing approval requests.

Embodiments of the inventive subject matter may make use of a dynamic authorization matrix, which may include or represent one or more matrices, such as an approval routing matrix and/or an assignment matrix, where different approval routing information may be defined (e.g., for a particular scenario that can trigger an approval process), such as the roles involved in the approval process, the number of participants from the particular role, the priority of the role in the approval process, whether the approvals should be sequential or parallel, and any pre-condition and/or post-condition handler information for each individual approval step.

Embodiments of the dynamic authorization matrix may make use of the concept of routes and, in some embodiments, the ability to have multiple routes and also the ability to execute these routes in either in sequential or parallel mode. Such flexibility may allow dynamic authorization matrix to cater to complex authorization needs of an enterprise. Some embodiments of the inventive subject matter may be illustrated by way of example:

1. In an organization O1, the requirement of the authorizations for any vendor payment above $100K can be:
a. If one executive approves the payment, a manager must approve the payment and then the approval of a VP of finance must be obtained
OR
b. If two executives approve the payment, then two managers must approve the payment, and the VP of finance need not approve the payment.
As will be illustrated herein, the above two approval scenarios of O1 can be mapped to the definition of “routes” in an approval routing matrix and within each route, the approvals are sought in sequence (one executive, then one manger and then one VP); however, the OR condition can be mapped to executing the routes in parallel.

2. In an organization O2, the requirement of the authorization for any change request approval can be:
a. A product manager OR an engineering manager or the program manager must approve the change request
THEN
b. An engineering Director OR VP of Engineering or VP of product management must approve the change request.
The above two approval scenarios can be mapped as two routes where the individual approvals within a route can execute in parallel but the routes must be executed in sequence.

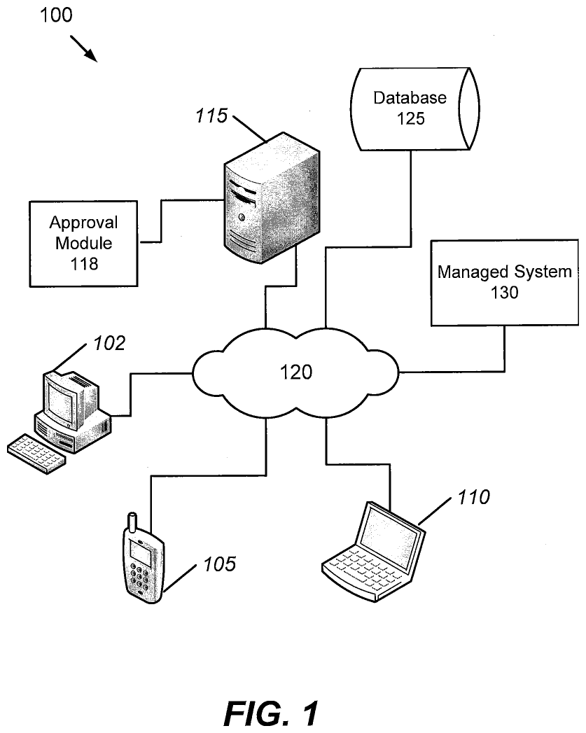

Referring to FIG. 1, a communication network including an approval server for managing approval requests using a dynamic authorization matrix, in accordance with some embodiments of the inventive subject matter, comprises client devices 102, 105, and 110 that are coupled to an approval server 115 and a managed system 130 via a network 120. The network 120 may be a global network, such as the Internet or other publicly accessible network. Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks. The client devices 102, 105, 110 may represent wired and/or wireless devices that include one or more applications that facilitate communication with the approval server 115 and the managed system 130. The client devices or terminals 102, 105, 110 may be connected directly to the approval server 115 and/or the managed system 130 without going through the network 120 in other embodiments of the inventive subject matter. It will be appreciated that in accordance with various embodiments of the inventive subject matter, the approval server 115 may be implemented as a single server, separate servers, or a network of servers either co-located in a server farm, for example, or located in different geographic regions. The client devices 102, 105, and 110 may be associated with one or more users that have various roles in an enterprise or organization associated with the managed system 130. The managed system 130 may include operations, processes, workflows, and the like that have matters associated therewith that may require approval of individuals within various roles in the organization. Thus, although only three client devices 102, 105, and 110 representing users having roles in an organization are shown, it will be understood that the number of roles and users associated with those roles is not limited in accordance with various embodiments of the inventive subject matter.

In some embodiments of the inventive subject matter, the approval server 115 may include an approval module 118 that is configured to manage approval requests for records in the managed system 130 using a dynamic authorization matrix for any type of entity that requires approvals, including, but not limited to, financial transactions and change requests. The dynamic authorization matrix may comprise and/or represent an approval routing matrix and/or an assignment matrix that may be stored in a database 125 or other information repository. The records representing the matters for approvals may be stored in the database 125 and/or other computer readable storage media/medium accessible to the approval server 115 and/or the managed system 130.

Although FIG. 1 illustrates an example communication network including an approval server 115 for managing approval requests using a dynamic authorization matrix, it will be understood that embodiments of the inventive subject matter are not limited to such configurations, but are intended to encompass any configuration capable of carrying out the operations described herein.

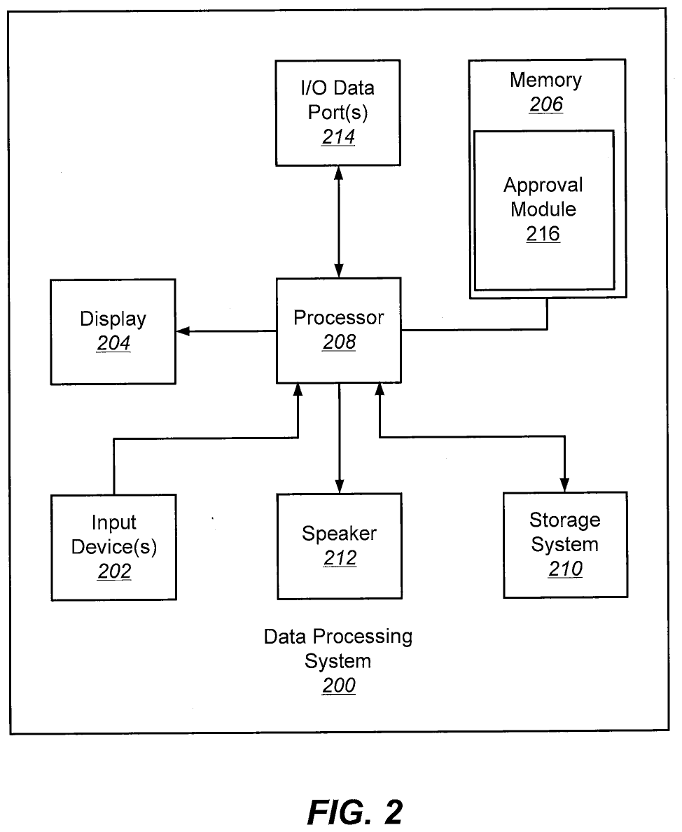

Referring now to FIG. 2, a data processing system 200 that may be used to implement the approval server 115 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with an approval module 216 that may provide functionality that may include, but is not limited to, managing approval requests using a dynamic authorization matrix, in accordance with some embodiments of the inventive subject matter.

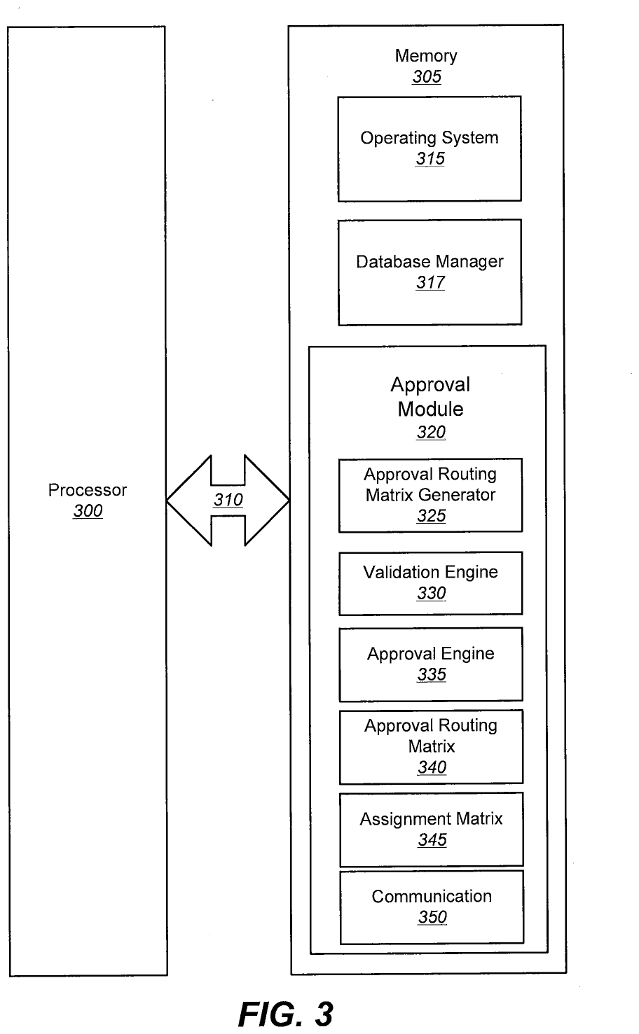

FIG. 3 illustrates a processor 300 and memory 305 that may be used in embodiments of data processing systems, such as the approval server 115 of FIG. 1 and the data processing system 200 of FIG. 2, respectively, for managing approval requests using a dynamic authorization matrix in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for managing approval requests using a dynamic authorization matrix in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain three or more categories of software and/or data: an operating system 315, a database manager 317, and an approval module 320. In particular, the operating system 315 may manage the data processing system's software and/or hardware resources and may coordinate execution of programs by the processor 300. The database manager 317 may comprise database management system (DBMS) software, which is used to facilitate the definition, creation, querying, update, and administration of a database, such as the database 125 of FIG. 1. The approval module 320 may comprise an approval routing matrix generation module 325, a validation engine 330, an approval engine 335, an approval routing matrix module 340, an assignment matrix module 345, and a communication module 350.

The approval routing matrix generator module 325 may be configured to generate the approval routing matrix 340 through definition of one or more routes comprising one or more roles representing individuals that are required for approving a matter that is represented as a record. Each route may specify the order in which individuals associated with the various roles may access the record and indicate their approval of the matter or deny approval of the matter. Each route may represent one combination of roles and an authorization order for approving or partially approving a matter. There may be other combinations of roles and/or authorization orders for approving or furthering the approval of the same matter. Accordingly, a record representing a matter may have multiple routes associated therewith. The order in which the routes are executed may be sequential or in parallel in accordance with various embodiments of the inventive subject matter. Moreover, the order in which users associated with the roles are allowed access to the record may be sequential or in parallel in accordance with various embodiments of the inventive subject matter.

The validation engine 330 may be configured to process the approval routing matrix 340 to identify conflicts and/or ambiguities in the defined routes, roles, and/or the priorities assigned thereto. These conflicts and/or ambiguities may be used as a basis for amending the approval routing matrix 340 and/or waiting until execution of the approval process has started to determine then whether to make amendments. The validation engine 330 may also be invoked during execution of the approval process when the approval routing matrix 340 is modified due to changing approval requirements, for example. The validation engine 330 may use example rules including, but not limited to the following:

1. The approval routing matrix 340 cannot have duplicate routes defined (i.e., the same combination of roles, users per role and priority).

2. For any individual route, the same role cannot appear more than once.

3. For multi-route definition in which all the routes are defined to run in parallel mode:
a. a role can appear at a given priority level in more than one route only if the same role has not been defined with higher priority in any other route;
b. a role can appear at a different priority level in more than one route if all the other roles defined at higher priority levels match.
c. the rule defined in 3b can be relaxed if the system will retain only one route, which it finds to be the best match after approval by any role is done, but with a restriction at the definition phase such that a role can appear at a given priority level in more than one route only if the same role has not been defined with highest priority in any other route.

The approval engine 335 may generate the assignment matrix 345 based on the approval routing matrix 340. When the approval engine 335 is invoked for the first time for a given matter for approval or record, the approval engine 335 loads the approval routing matrix corresponding to the approval trigger, i.e., the event that triggered a need to approve a matter. The approval engine 335 generates the assignment matrix 345 by extracting information from the approval routing matrix for the record associated with the matter for approval. Preparation of the assignment matrix 345 effectively denormalizes the data in the approval routing matrix 340 in a single matrix.

The communication module 350 may be configured to facilitate communication between the approval server 115 and the managed system 130, client devices 102, 105, and 110, and the database 125.

Although FIG. 3 illustrates hardware/software architectures that may be used in data processing systems, such as the approval server 115 of FIG. 1 and the data processing system 200 of FIG. 2, respectively, for managing approval requests using a dynamic authorization matrix in accordance with some embodiments of the inventive subject matter, it will be understood that the present invention is not limited to such a configuration but is intended to encompass any configuration capable of carrying out operations described herein.

Computer program code for carrying out operations of data processing systems discussed above with respect to FIGS. 1-3 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the approval server 115 of FIG. 1 and the data processing system 200 of FIG. 2, and the hardware/software architecture of FIG. 3, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

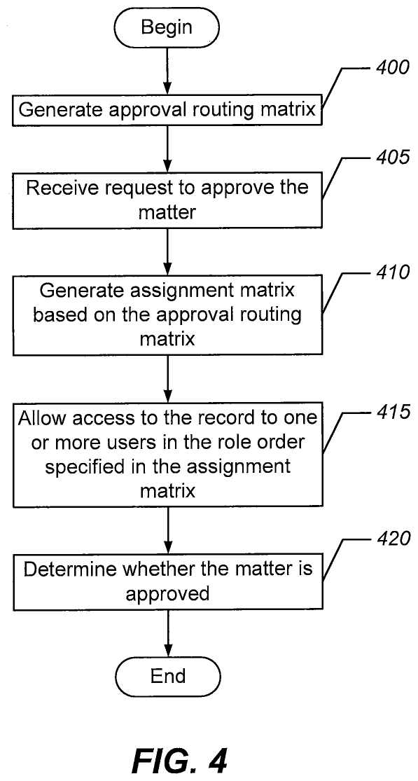

The data processing apparatus of FIGS. 1-3 may be used to facilitate managing approval requests using a dynamic authorization matrix according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 206 coupled to the processor 208 and the memory 305 coupled to the processor 300 may include computer readable program code that, when executed by the respective processors, causes the respective processors to perform operations including one or more of the operations described herein with respect to FIGS. 4, 5, 6A, 6B, and 7.

FIGS. 4, 5, 6A, 6B, and 7 are flowcharts that illustrate operations for managing approval requests using a dynamic authorization matrix that may be performed in whole or in part by one or more of the modules of FIG. 3. Referring to FIG. 4, operations begin at block 400 the approval routing matrix generator 325 generates the approval routing matrix. At block 405, an approval trigger may be generated based on a particular scenario, which is represented as a request to approve a particular matter, which may be represented as a record. The approval engine 335 may generate the assignment matrix 345 at block 410 based on the approval routing matrix 340. The approval engine 335 in managing the approval process may allow one or more users associated with roles in a defined route to view the record and indicate their approval of the matter or indicate a denial of approval for the matter. At block 420, the approval engine 335 may determine that the matter is approved once all required users for each role in a required number of routes have approved the matter.

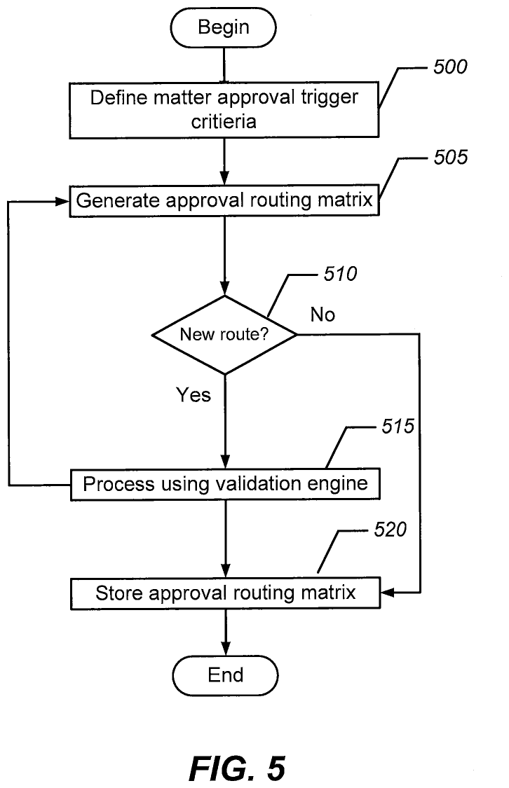

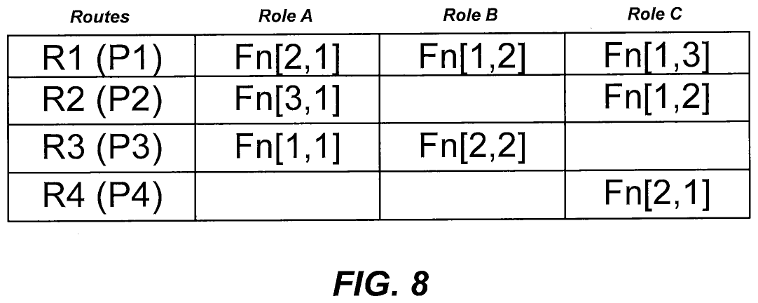

Referring to FIG. 5, generating the approval routing matrix 340, according to further embodiments of the inventive subject matter, begin at block 500 where the matter approval trigger criteria/criterion is defined. At block 505 the approval routing matrix 340 is generated through the creation of one or more routes. FIG. 8 illustrates an approval routing matrix 340 according to some embodiments of the inventive subject matter. As shown in FIG. 8, Routes 1-4 may be executed sequentially or in parallel. If the routes are executed in sequence, the priorities P1-P4 apply with P1 being the highest priority and P4 being the lowest priority. Three roles—Role A, Role B, and Role C—are defined The function Fn[X,Y] denotes the number of users X required to approve the matter/record for a particular role and the priority Y of the role relative to other roles. The example approval routing matrix 340 of FIG. 8 may be, for example, for an approval matter corresponding to a decision to take down a customer website for a time exceeding 30 minutes.

Returning to FIG. 5, when a new route is added as determined at block 510, the validation engine 330 may process the approval routing matrix 340 at block 515. The validation engine 330 may be used to detect conflicts and ambiguities in the definitions of the routes, roles, and/or priorities in the approval routing matrix 340. For the example of FIG. 8, if it is assumed that all the individual roles are defined to run in sequential mode and if all the routes are to be executed in parallel, then when three users from Role A have approved the record, users of Role C should be able to view the record as per Route 2, but as per Route 1, the users corresponding to Role C should not have access to the record unless at least one user from Role B has approved the record. This leads to an ambiguity because the visibility criteria for Role C are contradicting each other. Thus, the validation engine 330 may be configured to check for such runtime ambiguity. In some embodiments, it is also possible to define the routes in the approval routing matrix 340 such that when multiple routes are executed, at runtime, the system may choose to execute only one route after some time based on the best match. Referring again to FIG. 8, after one user from Role A has approved the record, the system can choose to execute only one route going forth and can retain Route 3 as the route to follow and may block all other routes. A large and complex approval routing matrix may progressively converge to a single route during execution. Returning to FIG. 5, when generation of the approval routing matrix 340 is complete as determined at block 510, the approval routing matrix is stored in a computer readable storage medium at block 520.

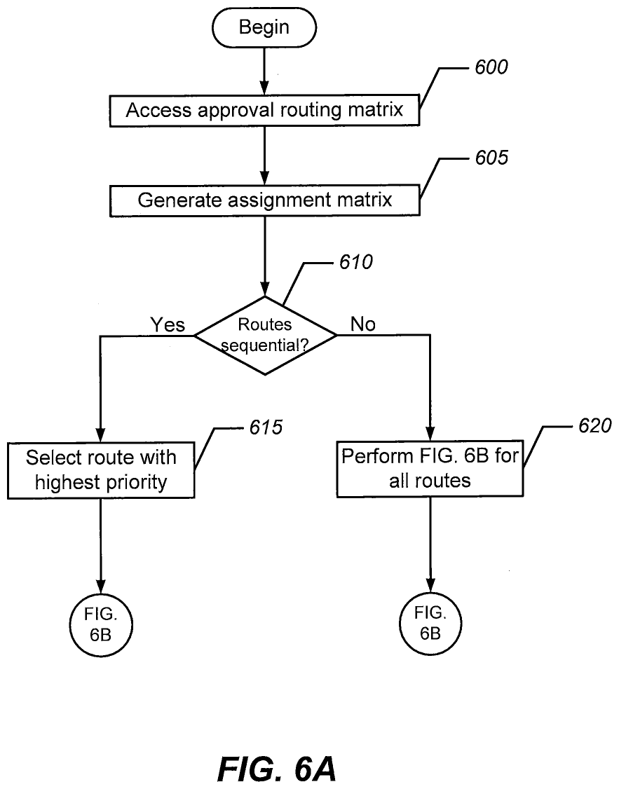

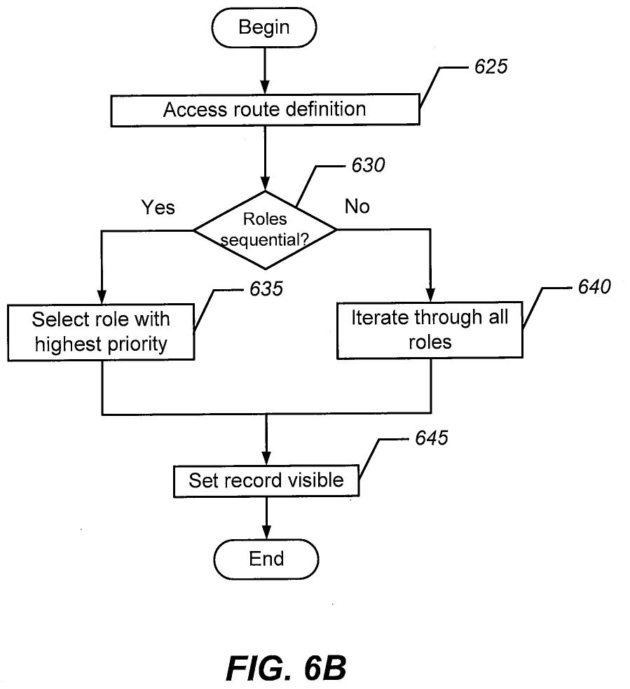

Referring to FIGS. 6A and 6B, generating the assignment matrix 345, according to further embodiments of the inventive subject matter, begin at block 600 where the approval routing matrix 600 is accessed and denormalized to generate the assignment matrix for a particular record at block 605. At block 610, a determination is made whether the routes for the record are to be executed sequentially or in parallel. At block 615, the route with the highest priority is selected and operations continue at FIG. 6B if the routes for the record are to be executed sequentially. At block 620, operations of FIG .6B are performed for all routes in parallel if the routes for the record are to be executed in parallel. Referring to FIG. 6B, the approval engine 335 may perform the operations of FIG. 6B for each of the routes in sequence based on priority or may perform the operations of FIG. 6B for all of the routes in parallel based on how the routes were defined in the approval routing matrix 340. Operations begin at block 625 where the approval engine 335 accesses the route definition. A determination is made whether the roles that have been defined for the route are to be given access to the record in parallel or sequentially at block 630. If the roles are to be given sequential access, then the role with the highest priority is selected at block 635 and the record is made visible to users associated with that role at block 645. If the roles are to be given access in parallel, then the approval engine 335 iterates through all of the roles at block 640 to provide the users associated with those roles parallel access at block 645.

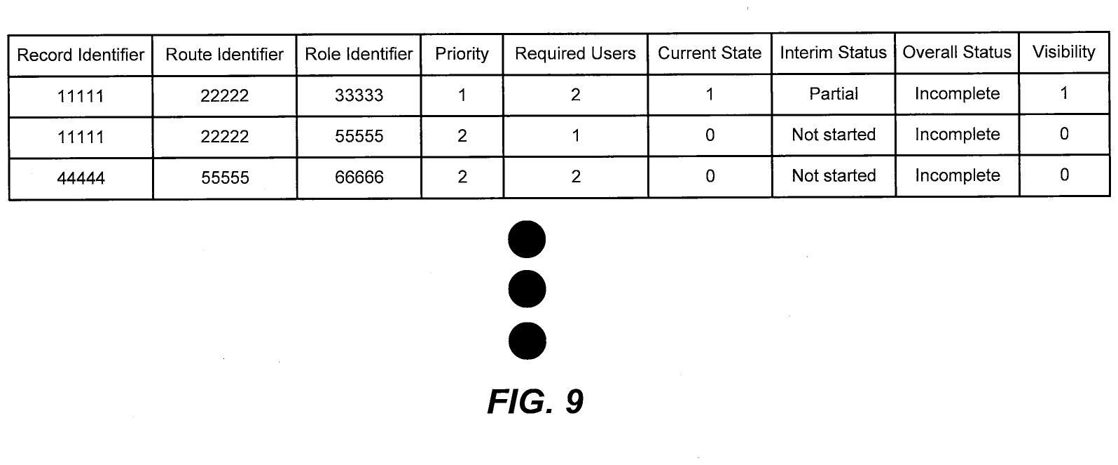

FIG. 9 is an example assignment matrix in which a record 11111 has one route that has been defined with two roles associated therewith. Role 33333 is given priority over Role 55555. Two users associated with Role 33333 are required for approval while one user associated with Role 55555 is required for approval. The record has been made visible to the two users associated with Role 33333. Thus, the current state flag is invoked for Role 33333 with a partial interim status as not all of the required users have approved yet. The overall status for the record 11111 is incomplete as the record has not been approved or denied approval.

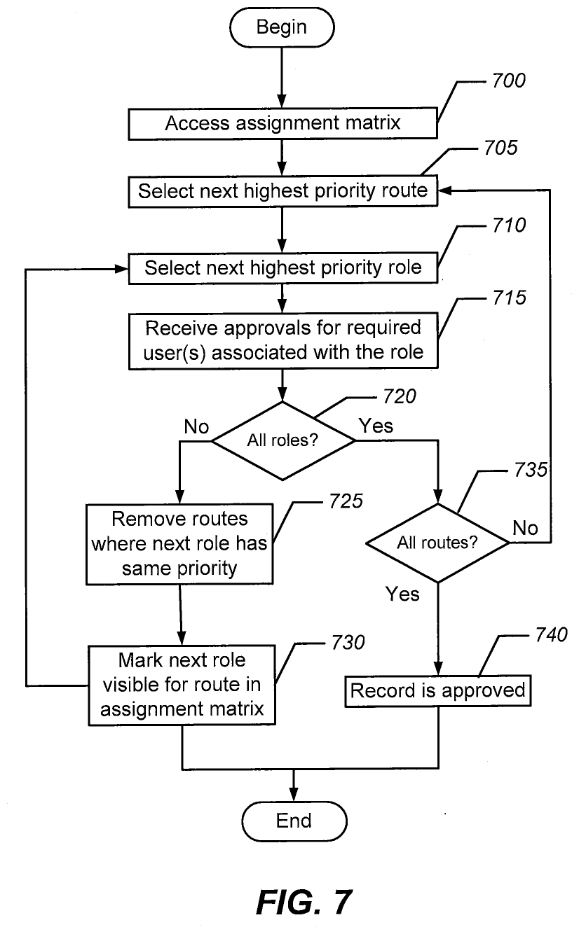

Referring to FIG. 7, operations for allowing access to a record for approval of a matter in which both routes and roles are executed sequentially, according to some embodiments of the inventive subject matter, begin at block 700 where the approval engine 335 accesses the assignment matrix 345 and selects the highest priority route at block 705. Operations continue at block 710 where the highest priority role is selected for the selected route. The approval engine 335 provides access to the record to the users associated with the selected role and receives approvals from the required users associated with the role at block 715. In some embodiments, any rejection of the record by a user associated with a role may result in the approval for the record being denied. A determination is made at block 720 whether all roles have been processed for the selected record. If not, then at block 725 those routes where the next role has the same priority as the previously processed role may be removed and the next role in the route is marked visible in the assignment matrix 345 allowing the next role to be selected at block 710. If, however, all of the roles associated with the route have been processed as determined at block 720, then the approval engine 335 checks for additional routes at block 735. If there are no additional routes to process, then the record is approved at block 740. If there are additional routes to process as determined at block 735, then operations continue at block 705 with the selection of the next highest priority route.

Embodiments of the inventive subject matter may provide an authorization methodology based on a dynamic authorization matrix comprising, for example, an approval routing matrix and an assignment matrix, which define paths for approval of a matter known as routes, which comprise one or more roles. Each individual route can be defined to be executed in either a sequential or parallel mode, which means if a route is in sequential mode then users from the role that has the highest priority will have visibility of the record representing the matter for approval first to approve/reject the matter. After the approval from the first role is complete, the record will be visible to the users of the role with the next priority. In the case of parallel mode, the priority does not matter and the record is visible to all the users of the roles involved in a route simultaneously and when the approval criteria of any role is satisfied, the record is marked as approved and no more approvals need be performed on the record.

Thus, in some embodiments of the inventive subject matter, routes can be executed in sequential or parallel mode. In the case of sequential execution, when the approval is done as per the route definition, the highest priority route is executed first, the route with the next highest priority is subsequently taken for execution. In the case of parallel mode, all the routes are executed in parallel where the roles in each individual route can be executed either sequential or parallel mode.

According to some embodiments of the inventive subject matter, the execution of the approval process is carried out by an approval engine 335, which unlike conventional workflows does not maintain a running state of the approval process operations in memory. When the approval process of a record is to be initiated based on a trigger condition, the approval engine is invoked, which in turn performs the routing of the record to appropriate participants (users associated with roles) for approval. Based on the approval process trigger condition, the approval engine 335 first locates the approval routing matrix 340 corresponding to the trigger condition; the approval engine 335 then translates the routes defined in the approval routing matrix 335 against the record in question and creates an assignment matrix 345 to perform the initial routing to users associated with the roles. In some embodiments, routing does not signify delivery of any action items to any users; instead, routing may signify the state transition of the execution or assignment matrix 345 in terms of who currently can view the record for approval. Users who are authorized to participate in the approval process may, in some embodiments, view the records through a separate interface, which can be a Web interface. The listing of the records for approval may query the assignment matrix 345 and other auxiliary information storage to display the records to the user. When a user approves/rejects a record, the approval engine 335 is invoked, which performs the state transition to reflect the changes in the assignment matrix 345 resulting from the recent approval/rejection.

More specifically, in some embodiments, after the preparation of the assignment matrix 345, the approval engine 335 determines the first set of roles which can view the record for approval based on the assignment matrix 345 and the approval routing matrix 340. The approval engine 335 first determines if there are multiple routes associated with that record and whether the routes are supposed to be executed in parallel/sequential mode. In the case of sequential mode, the approval engine 335 will select the route with the highest defined priority and proceed while in the case of parallel mode, the approval engine 335 iterates through the entire set of routes one by one. For each route, the engine determines whether the route itself has been defined to run in sequential or parallel mode. In the case of sequential mode, engine selects the role with the highest priority and may mark the visibility flag is the assignment matrix 345 as open against that role. In the case of parallel mode, the approval engine 335 may mark the visibility flag as open for all roles involved.

When the users of a particular role view the records pending for approval, they will only see those records whose visibility flag has been marked open for their role. When a user approves a particular transaction/record, the approval engine 335 may be invoked again, this time to determine the next set of roles who can now view the record for further approval if any. Based on the record information, the approval engine 335 first stores an indication that this particular user has approved/rejected the record, this may prevent the user from re-approving the same record. The approval engine 335 then accesses the assignment matrix 345 corresponding to the particular record and finds all the routes where the role of the user is a participant. If the individual routes have been setup to run in the sequential mode, then only a single route will match. In the case where the routes have been setup to execute in the parallel mode, then the approval engine 335 finds all the matching routes. Next, the approval engine 335 increments the required number of users for that role in all the matching routes and evaluates whether the criteria for that role have been fulfilled. For a particular route, if the criteria/criterion is met, then the approval engine 335 checks the role with the next highest priority level. If the same role appears in more than one route, then that role should not have visibility and the approval engine 335 may block that particular route and unset the visibility flag for all the roles in that route. As a result, that route is blocked from any further participation in the approval process. This situation may arise only when the validation engine 330 has been provided with input during the generation of the approval routing matrix 340 to allow such a conflict or ambiguity to occur.

After the increment of the user count and searching for the role with next highest priority level, if none is found, then in the case of parallel routes, the overall approval criteria has been met and the whole record can be marked complete. In the case where the routes have been defined to run in sequential mode, then the approval engine 335 may select the next highest priority route and perform the same operations as it has performed while processing the previous higher priority route. Rejection of a record may result in the blocking of all other routes and all other roles in the current route in some embodiments of the inventive subject matter.

In some embodiments of the inventive subject matter, approvals can be changed at runtime when the approval process is in progress for a particular record. For example, if a user intends to introduce one or more participant roles in the approval process, the system may allow such a modification without the restart or redeployment of the already in-progress approval process. While the system may allow such modifications to be done at the record level approvals, in some embodiments, the validation engine 330 may enforce some runtime restrictions on the allowable modification so as to avoid any ambiguity or conflict that may arise because of the proposed amendments on the entire approval process of the record.

According to some embodiments of the inventive concept, if approval is in progress for a record, then there will be entries in the assignment matrix 345 that reflect the current state of the approval process. The assignment matrix 345 may be a de-normalized version of the approval routing matrix 340, but on a per record basis. So, when a user tries to change the current approval process and approval is in progress for that particular record, then System cannot introduce any ambiguity in the rest of the approvals for that record. Performing changes to the in-progress approval process results in a change of the current state of the assignment matrix 345 for the record. In some embodiments of the inventive subject matter, rules may be applied to restrict the type of changes that can be made to the assignment matrix 345. The following types of changes may be subject to restriction according to some embodiments of the inventive subject matter:

1. If a user with sufficient privileges performs an addition or removal of particular route(s).

2. If a user with sufficient privileges performs amendments to a particular route, such as:
a. adding more roles to the route
b. changing the required number of users for a particular role
c. remove a role

In response to these types of changes, for example, the validation engine 330 evaluates the changes against the constraints that it imposes during the initial generation of the approval routing matrix. When the approval process is in-progress, more restrictions may be placed on the allowable modifications that can be performed. These restrictions may include, but are not limited to the following examples:

the required number of users for a particular role may not be changed if the criteria of the role are already fulfilled and users from the next role in priority can already view the record for approval; and

new roles can be introduced in a route if the visibility criteria are not contradicted. For example, if there are only two routes defined, in the first route, it is defined that if two users from role A completes then one user from role B can approve/reject the transaction and in the second route, it is defined that if three users from role A approve the transaction then one user from role C can approve the transaction. If an attempt is made to replace role C with role B, then an ambiguity will arise for the visibility of the transaction to role B.

Because embodiments of the inventive subject matter do not rely on any in-memory state of the current record approval in-progress, with proper validation in place via the validation engine 330, the approval routes can be changed at runtime to suit changing needs.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
performing by a processor, operations comprising:
generating an approval routing matrix that is configured to associate a route with at least one a plurality of roles for accessing a record in a storage medium, the record being representative of a matter for approval;
receiving a request to approve the matter;
generating an assignment matrix based on the approval routing matrix, the assignment matrix being configured to specify an order in which the at least one of the plurality of roles are granted access to the record;
allowing access to the record to at least one user associated with the at least one of the plurality of roles, respectively, in the order specified in the assignment matrix; and
determining whether the matter is approved based on input received by the at least one user associated with the at least one of the plurality of roles, respectively.

2. The method of claim 1, wherein the route is a first route and the at least one of the plurality of roles is a first at least one of the plurality of roles; and
wherein the approval routing matrix is further configured to associate respective ones a plurality of routes with respective ones of at least one of the plurality of roles; and
wherein the plurality of routes comprises the first route and the respective ones of at least one of the plurality of roles comprises the first at least one of the plurality of roles.

3. The method of claim 2, wherein the approval routing matrix is further configured to associate a route priority with each of the plurality or routes; and
wherein the approval routing matrix is further configured to associate a role priority with each of the at least one of the plurality of roles associated with respective ones of the plurality of routes.

4. The method of claim 3, wherein the assignment matrix is further configured to specify respective ones of a plurality of orders in which the respective ones of the at least one of the plurality of roles associated with respective ones of the plurality of routes are granted access to the record;
wherein allowing access to the record comprises allowing access to the record to respective ones of at least one user associated with respective ones of the at least one of the plurality of roles associated with respective ones of the plurality of routes based on the plurality of orders specified in the assignment matrix; and
wherein the plurality of orders specified in the assignment matrix comprises the order specified in the assignment matrix.

5. The method of claim 4, wherein the approval routing matrix is further configured to specify respective required numbers of ones of at least one user associated with respective ones of the at least one of the plurality of roles associated with respective ones of the plurality of routes.

6. The method of claim 4, wherein each of the plurality of routes has a same route priority that has been associated therewith; and
wherein allowing access to the record comprises allowing access to the record to respective ones of at least one user associated with respective ones of the at least one of the plurality of roles associated with different respective ones of the plurality of routes in parallel.

7. The method of claim 6, wherein the respective ones of the at least one of the plurality of roles associated with one of the plurality of routes has a same role priority that has been associated therewith; and
wherein allowing access to the record comprises allowing access to the record to the respective ones of the at least one user associated with respective ones of the at least one of the plurality of roles associated with the one of the plurality of routes in parallel.

8. The method of claim 6, wherein the respective ones of the at least one of the plurality of roles associated with one of the plurality of routes have different role priorities, respectively, that have been associated therewith; and
wherein allowing access to the record comprises allowing access to the record to the respective ones of the at least one user associated with respective ones of the at least one of the plurality of roles associated with the one of the plurality of routes in in sequence based on the different role priorities that have been associated with the at least one of the plurality of roles associated with the one of the plurality of routes.

9. The method of claim 4, wherein respective ones of the plurality of routes have different route priorities, respectively, that have been associated therewith; and
wherein allowing access to the record comprises allowing access to the record to respective ones of at least one user associated with respective ones of the at least one of the plurality of roles associated with different respective ones of the plurality of routes in sequence based on the different route priorities that have been associated with the plurality of routes, respectively.

10. The method of claim 9, wherein the respective ones of the at least one of the plurality of roles associated with one of the plurality of routes has a same role priority that has been associated therewith; and
wherein allowing access to the record comprises allowing access to the record to the respective ones of the at least one user associated with respective ones of the at least one of the plurality of roles associated with the one of the plurality of routes in parallel.

11. The method of claim 9, wherein the respective ones of the at least one of the plurality of roles associated with one of the plurality of routes have different role priorities, respectively, that have been associated therewith; and
wherein allowing access to the record comprises allowing access to the record to the respective ones of the at least one user associated with respective ones of the at least one of the plurality of roles associated with the one of the plurality of routes in in sequence based on the different role priorities that have been associated with the at least one of the plurality of roles associated with the one of the plurality of routes.

12. The method of claim 4, further comprising:
determining that the role priority or a number of the at least one user of a first one of the at least one of the plurality of roles associated with a first one of the plurality routes conflicts with the role priority or a number of the at least one user of the first one of the at least one of the plurality of roles associated with a second one of the plurality of routes.

13. The method of claim 12, further comprising:
modifying the role priority or the number of the at least one user of the first one of the at least one of the plurality of roles associated with the first one of the plurality of routes.

14. The method of claim 12, further comprising:
removing the first one of the plurality of routes from the approval routing matrix.

15. The method of claim 4, further comprising:
determining, after allowing access to the record, that the role priority of a first one of the at least one of the plurality of roles associated with a first one of the plurality routes conflicts with the first one of the at least one of the plurality of roles associated with a second one of the plurality of routes; and
removing the first one of the plurality of routes from the assignment matrix.

16. The method of claim 4, wherein determining whether the matter is approved comprises:
receiving input from one of the at least one user associated with one of the least one of the plurality of roles associated with one of the plurality of routes that the matter is not approved; and
determining that the matter has not been approved based on the input received.

17. The method of claim 4, wherein determining whether the matter is approved comprises:
receiving input from respective ones of the at least one user associated with respective ones of the at least one of the plurality of roles associated with one of the plurality of routes that the matter is approved; and
determining that the matter has been approved based on the inputs received.

18. A system, comprising:
a processor; and
a memory coupled to the processor and comprising computer readable program code embodied in the memory that is executable by the processor to perform operations comprising:
generating an approval routing matrix that is configured to associate a route with at least one a plurality of roles for accessing a record in a storage medium, the record being representative of a matter for approval;
receiving a request to approve the matter;
generating an assignment matrix based on the approval routing matrix, the assignment matrix being configured to specify an order in which the at least one of the plurality of roles are granted access to the record;
allowing access to the record to at least one user associated with the at least one of the plurality of roles, respectively, in the order specified in the assignment matrix; and
determining whether the matter is approved based on input received by the at least one user associated with the at least one of the plurality of roles, respectively.

19. The system of claim 18, wherein the route is a first route and the at least one of the plurality of roles is a first at least one of the plurality of roles; and
wherein the approval routing matrix is further configured to associate respective ones a plurality of routes with respective ones of at least one of the plurality of roles;
wherein the approval routing matrix is further configured to associate a route priority with each of the plurality or routes;
wherein the approval routing matrix is further configured to associate a role priority with each of the at least one of the plurality of roles associated with respective ones of the plurality of routes;
wherein the assignment matrix is further configured to specify respective ones of a plurality of orders in which the respective ones of the at least one of the plurality of roles associated with respective ones of the plurality of routes are granted access to the record;
wherein allowing access to the record comprises allowing access to the record to respective ones of at least one user associated with respective ones of the at least one of the plurality of roles associated with respective ones of the plurality of routes based on the plurality of orders specified in the assignment matrix;
wherein the plurality of routes comprises the first route and the respective ones of at least one of the plurality of roles comprises the first at least one of the plurality of roles; and
wherein the plurality of orders specified in the assignment matrix comprises the order specified in the assignment matrix.

20. A computer program product comprising:
a tangible computer readable storage medium comprising computer readable program code embodied in the medium that is executable by a processor to perform operations comprising:
generating an approval routing matrix that is configured to associate a route with at least one a plurality of roles for accessing a record in a storage medium, the record being representative of a matter for approval;
receiving a request to approve the matter;
generating an assignment matrix based on the approval routing matrix, the assignment matrix being configured to specify an order in which the at least one of the plurality of roles are granted access to the record;
allowing access to the record to at least one user associated with the at least one of the plurality of roles, respectively, in the order specified in the assignment matrix; and
determining whether the matter is approved based on input received by the at least one user associated with the at least one of the plurality of roles, respectively.
